(19) United States
(12) Patent Application Publication
(10) Pub. No.: US 2007/0159928 A1
(43) Pub. Date: Jul. 12, 2007

(54) Digital display type radio-corrected timepiece and standard wave receiving method of the timepiece

(76) Inventor: Shoji Nirasawa, Chiba-shi (JP)

Correspondence Address: BRUCE L. ADAMS, ESQ., SUITE 1231, 17 BATTERY PLACE, NEW YORK, NY, 10004, US

(21) Appl. No.: 11/643,312

(22) Filed: Dec. 21, 2006

(30) Foreign Application Priority Data
Jan. 12, 2006 (JP) 2006-004638

(51) Int. Cl. G04C 11/02

(52) U.S. Cl. 368/47

(57) ABSTRACT

To provide a digital display type radio-corrected timepiece capable of maintaining a signal reception performance of a reception antenna while avoiding an increase in a size, and a standard wave receiving method of the timepiece. In a digital display type radio-corrected timepiece having a display digital-displaying a time instant data including an hour/minute, when correcting a display time instant of the display performing a digital display on the basis of a time instant information included in a standard wave signal JJY received by a reception antenna which is disposed in one side of the display performing the digital display, while the time instant information is being received, there is stopped an input of a display signal from the one side of the display to the display.

### BACKGROUND OF THE INVENTION

1. Field of the Invention

The present invention is related to a digital display type radio-corrected timepiece (i.e., a digital display type radio-controlled timepiece) and a standard wave receiving method of the timepiece, and more detailedly related to a digital display type radio-corrected timepiece suitable for being used as a portable and small timepiece like a wristwatch and a standard wave receiving method of the same.

2. Description of the Prior Art

There is publicly known a radio-corrected timepiece which receives a standard wave in which an hour/minute/second data has been carried on a long wave of 40 kHz or 60 kHz in addition to a date data, thereby performing a time instant correction on the basis of a time instant information taken out from the standard wave.

A conventional digital display type radio-corrected timepiece in the form of wristwatch possesses a liquid crystal display in the form of liquid crystal panel digital-displaying a time instant data including the hour/minute/second and a non-time instant data other than the former, possesses a circuit block outputting a signal which denotes the time instant data for display, and additionally possesses a reception antenna, which receives a standard wave signal including a time instant information, in the vicinity of the liquid crystal display panel.

The reception antenna is disposed along an outer edge of a circuit substrate of the circuit block. Incidentally, there is also the fact that a notch for disposing the reception antenna is formed in the outer edge (for example, JP-UM-A-6-25792).

In any case, in the conventional digital display type radio-corrected timepiece, at least one part of a wiring for inputting a digital type display data from a timepiece circuit of the circuit block to the liquid crystal display panel has been inputted to the liquid crystal panel in one side, within the liquid crystal display panel, facing on the reception antenna located in the vicinity of the panel.

Accordingly, when the reception antenna receives the standard wave and the time instant information is taken out from the standard wave, the reception antenna unavoidably undergoes some influence of a noise resulting from the signal passing through the wiring for inputting the digital type display data to the liquid crystal display panel, so that it has been natural that an S/N ratio in a detection of the time instant information of the standard wave somewhat decreases.

Incidentally, if the reception antenna is separated sufficiently apart from the liquid crystal panel, it is possible to avoid this problem. However, in this case, a size of the timepiece becomes large, and it follows that a design and a practicality are impaired.

### SUMMARY OF THE INVENTION

The present invention has been made in view of the above-mentioned points, and its object is to provide a digital display type radio-corrected timepiece capable of maintaining a signal reception performance of the reception antenna while avoiding an increase in the size, and a standard wave receiving method of the timepiece.

In order to achieve the above object, a digital display type radio-corrected timepiece of the present invention is a digital display type radio-corrected timepiece having possessed a display digital-displaying a time instant data including an hour/minute, having a reception antenna disposed near one side of the display and receiving a standard wave signal including a time instant information, a timepiece circuit forming a time instant data corrected on the basis of the time instant information of the standard wave signal received by the antenna, and a time instant data displaying output line comprising a wiring for sending a displaying output signal including the time instant data from the timepiece circuit to the display, wherein the time instant data displaying output line is connected to the display in a place, of the display, different from the one side adjoining the reception antenna.

In the digital display type radio-corrected timepiece of the present invention, since “the time instant data displaying output line comprising the wiring for sending the displaying output signal including the time instant-data from the timepiece circuit to the display is connected to the display in the place, of the display which digital-displays the time instant data including the hour/minute, different from the one side adjoining the reception antenna which receives the standard wave signal including the time instant information”, the reception antenna is located in a place separated from the time instant data displaying output line. Therefore, in order to always display the time instant data in the digital type by the display, even if the time instant data including the hour/minute is continued to be inputted to the display through the time instant data displaying output line, there is practically no fear that a signal for the display data transmitted through the time instant data displaying output line forms a noise which decreases a reception performance of the reception antenna. Accordingly, in the digital display type radio-corrected timepiece of the present invention, even if the size is suppressed to a lowest limit by disposing the reception antenna while adjoining the display, a signal reception performance of the reception antenna can be maintained, and further it becomes also possible to increase a reception sensitivity.

In the digital display type radio-corrected timepiece of the present invention, the “data including an hour/minute” means a data including an information specifying the “hour” and the “minute” at each point of time. Typically, although it includes also an information specifying the “second” at each point of time, the “second” data may not be included, and the “second” may not be displayed.

In the digital display type radio-corrected timepiece of the present invention, in relation to the display, a “digital (type)” means one in which the display is displayed typically by a “numerical value”, and indicates that it differs from an “analog (type)” by a pointer continuously changing with respect to a graduation. In the digital type display like this, since the number of signal lines given to the display in order to denote the data to be displayed becomes many, a region that the signal lines occupy becomes large, and an electric signal flowing through the signal lines is liable to become a noise source with respect to the standard wave reception antenna.

On the other hand, in the digital display type radio-corrected timepiece of the present invention, i.e., in this specification, the “non-time instant data” is a data not indispensable for displaying a time instant at present as the radio-corrected timepiece normally used, and means a data other than “the above time instant data”. For example, it is deemed that not only an information, like a battery residual quantity, having no relation with an information specifying the “hour” and the “minute” at each point of time but also a so-called “calendar” data, i.e., a “day” data and a “day of the week” data, and the “non-time instant data” are classified as the non-time instant data. The non-time instant data is the calendar data denoting the day or a term longer than the day, or a data not depending on the time instant. As the data not depending on the time instant, it may be also a data relating to a function other than the timepiece function.

Incidentally, in the digital display type radio-corrected timepiece of the present invention, typically, in a case where the display is constituted so as to additionally digital-display a non-time instant data other than the time instant data, there are additionally provided a non-time instant data generation means forming the non-time instant data, a non-time instant data displaying output line comprising a wiring connecting the non-time instant data generation means and the one side of the display, and a non-time instant data display control means controlling a transmission of the non-time instant data to the display through the non-time instant data displaying output line, and the non-time instant data display control means is constituted so as to stop the transmission of the non-time instant data to the display while the reception antenna is receiving the standard wave signal in order that the timepiece circuit performs a time instant correction on the basis of the time instant information of the standard wave signal.

In this case, since “the non-time instant data display control means is constituted so as to stop the transmission of the non-time instant data to the display while the reception antenna is receiving the standard wave signal in order that the timepiece circuit performs the time instant correction on the basis of the time instant information of the standard wave signal”, even if the non-time instant data displaying output line is connected to the display in the one side adjoining the reception antenna of the display, a non-time instant data displaying signal is not inputted to the display from the non-time instant data displaying output line while the standard wave signal is being received for a time instant correction by the reception antenna. Therefore, there is no fear that the reception antenna picks up a noise resulting from the non-time instant data displaying signal. Accordingly, in the digital display type radio-corrected timepiece of this invention, a signal reception performance of the reception antenna can be maintained while avoiding the increase in the size.

Incidentally, so long as it is possible to stop a transmission of the non-time instant data to the display, a formation itself of the non-time instant data may be stopped, without limiting to a mere stop of the transmission.

However, in the digital display type radio-corrected timepiece of the present invention, instead of the non-time instant data displaying output line being connected to the one side of the display, it may be connected to the display in a place, of the display, different from the one side adjoining the reception antenna. In that case, even if the non-time instant data is continued to be always displayed, the fact that there exists practically no fear that the signal reception performance by the reception antenna decreases is similar to the above-mentioned case.

In the digital display type radio-corrected timepiece of the present invention, typically, the timepiece circuit and the non-time instant data display control means are mounted to a circuit substrate, and the circuit substrate possesses a wiring pattern constituting the time instant data displaying output line and the non-time instant data displaying output line.

In the digital display type radio-corrected timepiece of the present invention, typically, the display possesses in the one side thereof a non-time instant data displaying input terminal including many display signal inputting contact portions, the non-time instant data displaying output line possesses in an end part of the display side a non-time instant data displaying output terminal including many display signal outputting contact portions, and the non-time instant data displaying output terminal of the non-time instant data displaying output line is connected through a connector to the non-time instant data displaying input terminal of the display between the display and the reception antenna.

In this case, the connector comprises, e.g., a rubber-like body in which an electrically conducting layer and an insulating layer are laminated in order to electrically connect respectively many contacts of the displaying output terminal and many contacts of the displaying input terminal between the non-time instant data displaying output terminal of the non-time instant data displaying output line of the circuit substrate and the non-time instant data displaying input terminal of the display. However, the connector may be one of other forms such as, e.g., a combination of a male type and a female type. Further, the non-time instant data displaying output terminal of the non-time instant data displaying output line of the circuit substrate and the non-time instant data displaying input terminal of the display may be directly connected without other electrical/mechanical connection means-intermediately.

In the digital display type radio-corrected timepiece of the present invention, although the display is, typically, a liquid crystal display type, instead of this, it may be one of a light emitting diode type, an organic EL (electroluminescence) display type, or other digital display type like an electronic paper type. In a case where the display is, e.g., the liquid crystal display type, any one will do so long as it can perform the digital display, and it may be a type having a segment electrode or a fixed pattern electrode, a type having a matrix electrode, or a type in which the formers are used in combination. Further, also as to a drive system of the liquid crystal display type, in a case of the segment electrode, it may be a static drive system or a dynamic drive system and, in a case of the matrix electrode, it may be a passive matrix drive system or an active matrix drive system. Although a tint display is typically a white/black display from a restriction of a battery capacity, it may be a color display. Although also a liquid crystal display system is typically an STN shape for a white/black display, instead of this, it may be one of a twisted TN shape, an FLC (ferroelectricity) shape, a GH (guest/host) shape, an ECB (birefringence control) shape, a PD (polymer dispersion) shape, an IPS (in-face switching) shape, or other whatever form.

In the digital display type radio-corrected timepiece of the present invention, typically, the display possesses an elongated plane shape, and the reception antenna is disposed along a long side forming the one side of the display. However, the display may be a non-elongated shape like a circle, a square, or a regular polygon. The reception antenna may be disposed along a short side within the elongated plane shape. The antenna may be linear or curved.

In the digital display type radio-corrected timepiece of the present invention, typically, the reception antenna is disposed in a 12 o'clock side (an upper edge or an upper side of the display when seen facing on the display) or a 6 o'clock side (a lower edge or a lower side of the display) in a case of an analog type display. However, instead of this, it may be disposed in a 3 o'clock side or a 9 o'clock side, and further it may be disposed in other position in a slant direction.

The digital display type radio-corrected timepiece of the present invention is, typically, a portable timepiece, and is typically in the form of a wristwatch. However, e.g., it may be incorporated into a portable telephone or other portable equipment.

Further, in order to achieve the above object, a standard wave receiving method of a digital display type radio-corrected timepiece of the present invention has been adapted such that when correcting a display time instant of a display, which performs a digital display, on the basis of a time instant information included in a standard wave signal received by a reception antenna disposed in one side of the display, an input of a display signal from the one side of the display to the display is stopped while the time instant information is being received.

In this case, the fact that there exists no fear that a performance of the radio correction by the reception antenna decreases is as mentioned before.

### BRIEF DESCRIPTION OF THE SEVERAL VIEWS OF THE DRAWINGS

A preferred form of the present invention is illustrated in the accompanying drawings in which:

FIG. 1 are ones having shown main portions of a digital display type radio-corrected timepiece of one preferred example by the present invention, wherein FIG. 1A is a plan explanatory view (however, a wiring pattern located behind a liquid crystal display part is clearly shown by dotted lines such that its overlapping state is understood), and FIG. 1B a sectional explanatory view along a line IB-IB in FIG. 1A;

FIG. 2 is a plan explanatory view of a circuit block of the radio-corrected timepiece of FIG. 1;

FIG. 3 is a plan explanatory view of a liquid crystal display part of the radio-corrected timepiece of FIG. 1;

FIG. 4 is an external appearance explanatory view of the radio-corrected timepiece of FIG. 1;

FIG. 5 is a functional relation block diagram schematically showing a function of the radio-corrected timepiece of FIG. 1; and

FIG. 6 is an explanatory view schematically showing a display stop control of a non-time instant data by the radio-corrected timepiece of FIG. 1.

### DETAILED DESCRIPTION OF THE PREFERRED EMBODIMENTS

One preferred embodiment of the present invention is explained on the basis of one preferred example shown in the appended drawings.

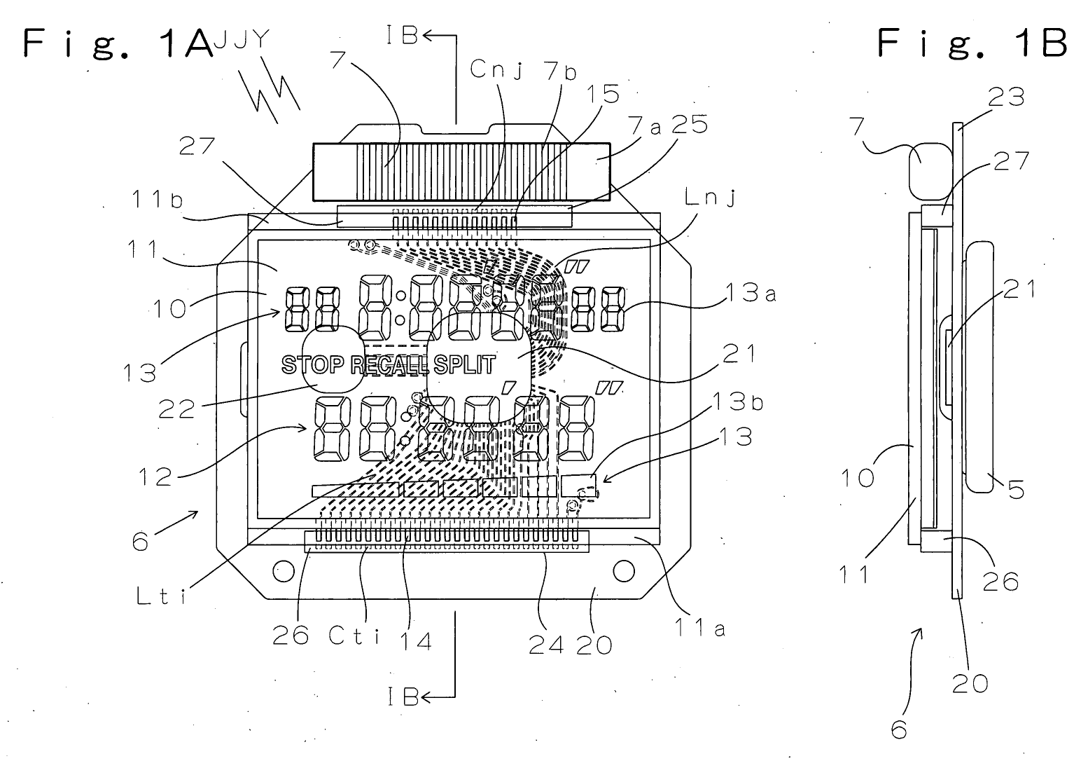

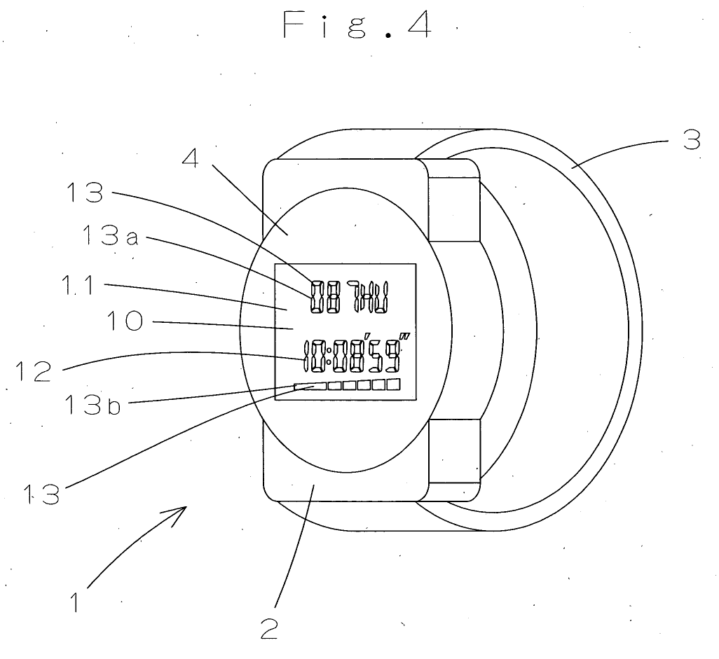

As schematically shown in FIG. 4, a digital display type radio-corrected wristwatch 1 of one preferred example of the present invention has a wrist watch part 2 having a liquid crystal display part 10 as a digital type display, and an arm wearing timepiece band part 3. The wristwatch part 2 has a case 4, and a timepiece main body part 6 disposed in the case 4 and electricity-supplied by a battery 5 as shown in FIG. 1.

As shown in FIGS. 1A and 1B, the timepiece main body part 6 includes a circuit block 20 including an integrated circuit (timepiece IC) 21 for the timepiece main body and a receiving integrated circuit (reception IC) 22, a liquid crystal display part 10 for the digital display, a reception antenna 7 receiving a standard wave JJY including the time instant information, and the like.

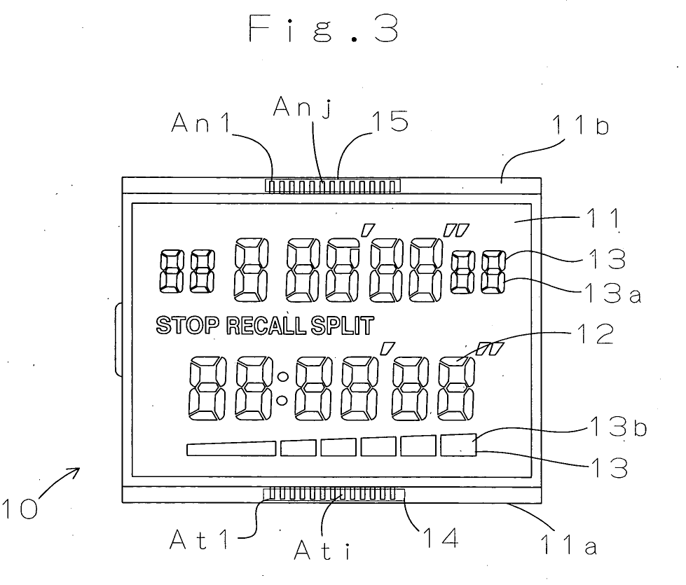

As understood from FIG. 1A and FIG. 3, in this instance, the liquid crystal display part 10 comprises a liquid crystal panel 11 in the form of a laterally long rectangle within a display region, possesses a segment type time instant display part 12 which digital-displays “hour/minute/second” as a time instant data Dt by numerical values in a somewhat lower part (lower stage) of a center thereof, possesses a segment type calendar display part 13a which displays in a digital type such calendar information as “day” and “day of the week” as a 1st non-time instant data Dn1 in an upper part (upper stage) thereof, and additionally possesses one kind of segment type battery residual quantity display part 13b which digital-displays a 2nd non-time instant data Dn2, such as battery residual quantity, having no relation with a present time instant in a lowermost stage thereof. In this instance, a non-time instant data display part 13 comprises the calendar display part 13a and the battery residual quantity display part 13b. The liquid crystal panel 11 has additionally, in its lower side edge part 11a and upper side edge part 11b, data input terminal parts 14, 15 for digital display. Here, the time instant data input terminal 14 in the lower stage is a data input terminal for inputting the time instant data Dt, and the non-time instant data input terminal 15 in the upper stage is a data input terminal for inputting a non-time instant data Dn like “calendar data Dn1” and “battery residual quantity data Dn2”.

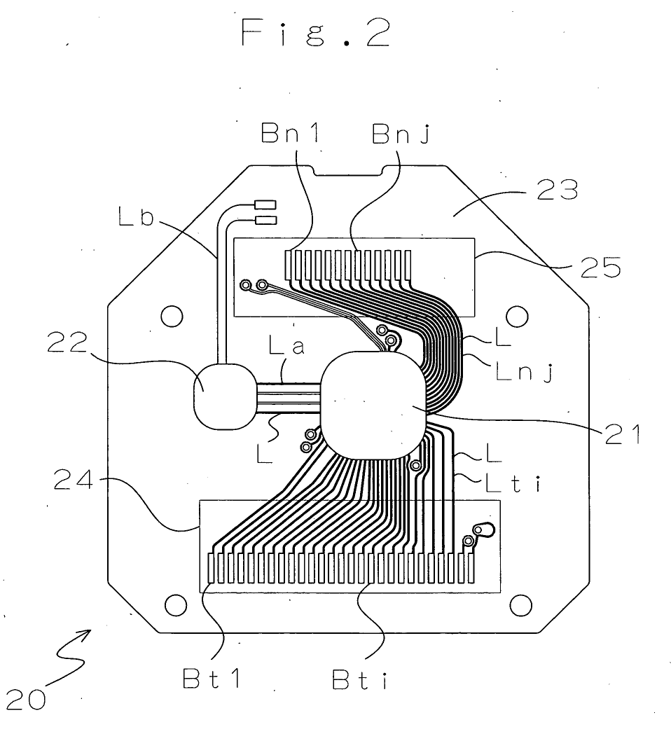

As understood from FIG. 2 and FIG. 3 in addition to FIG. 1, the time instant data input terminal 14 includes many inputting contact portions Ati corresponding to a wiring pattern group (transmitting wiring) Lti as many time instant data displaying output lines for digital-displaying the time instant data Dt of hour/minute/second. Similarly, the non-time instant data input terminal 15 includes many inputting contact portions Anj corresponding to a wiring pattern group (transmitting wiring) Lnj as many non-time instant data displaying output lines for digital-displaying the non-time instant data.

As understood from FIG. 2 in addition to FIG. 1, the circuit block 20 includes a circuit substrate 23 in which a timepiece IC 21 and a reception IC 22 have been mounted, and many wiring patterns L are formed in the circuit substrate 23. A wiring pattern L of the circuit substrate 23 includes a time instant data outputting wiring pattern group Lti and a non-time instant data outputting wiring pattern group Lnj, in addition to a wiring pattern La connecting the timepiece IC 21 and the reception IC 22, and a wiring pattern Lb connecting the reception IC 22 and the reception antenna 7. One end of the time instant data outputting wiring pattern group Lti becomes a time instant data output terminal 24, and the time instant data output terminal 24 includes many time instant data outputting contact portions Bti corresponding to the many time instant data displaying output lines Lti. One end of the non-time instant data displaying output line Lnj becomes a non-time instant data output terminal 25, and the non-time instant data output terminal 25 includes many non-time instant data outputting contact portions Bnj corresponding to the many signal lines Lnj.

Connectors 26, 27 are disposed between the time instant data and non-time instant data output terminals 24, 25 of the substrate 23 of the circuit block 20 and the time instant data and non-time instant data input terminals 14, 15 of the liquid crystal panel 10. The connector 26 consists of a rubber-like elastic body in which many conductive layers Cti have been laminated and integrated through insulating layers, and connects each of the time instant data outputting contact portions Bti of the circuit block 20 and each of the time instant data inputting contact portions Ati of the liquid crystal panel 11. Similarly to the connector 26, the connector 27 consists of the rubber-like elastic body in which many conductive layers Cnj have been laminated and integrated through insulating layers, and connects each of the non-time instant data outputting contact portions Bnj of the circuit block 20 and each of the non-time instant data inputting contact portions Anj of the liquid crystal panel 11.

Incidentally, e.g., in such a case that the substrate 23 consists of a flexible substrate, instead of using the connectors 26, 27, the data outputting contact portions Ati, Anj of the substrate 23 of the circuit block 20 and the corresponding data inputting contact portions Bti, Bnj of the liquid crystal panel 11 may be directly connected by a thermo compression bonding or other means, and a method of the connection can be selected in compliance with a desire.

The reception antenna 7 is formed by winding in many turns an insulating coated conductor wire 7b around a rod-like magnetic core 7a, and fixed to the circuit substrate 23 along the non-time instant data outputting connector 26 and an upper edge of the liquid crystal panel 11. Incidentally, instead of this, there may be adapted such that a notch is previously formed in an upper edge part 23a of the circuit substrate 23, the reception antenna 7 is disposed in the notch, and the reception antenna 7 is stationally disposed with respect to a case by a rigid panel frame of the liquid crystal panel 11, a rigid battery frame of the battery 5, or other desirable fixation support means or positioning means. The wound wire 7b of the reception antenna 7 is connected to the reception IC through the wiring pattern Lb.

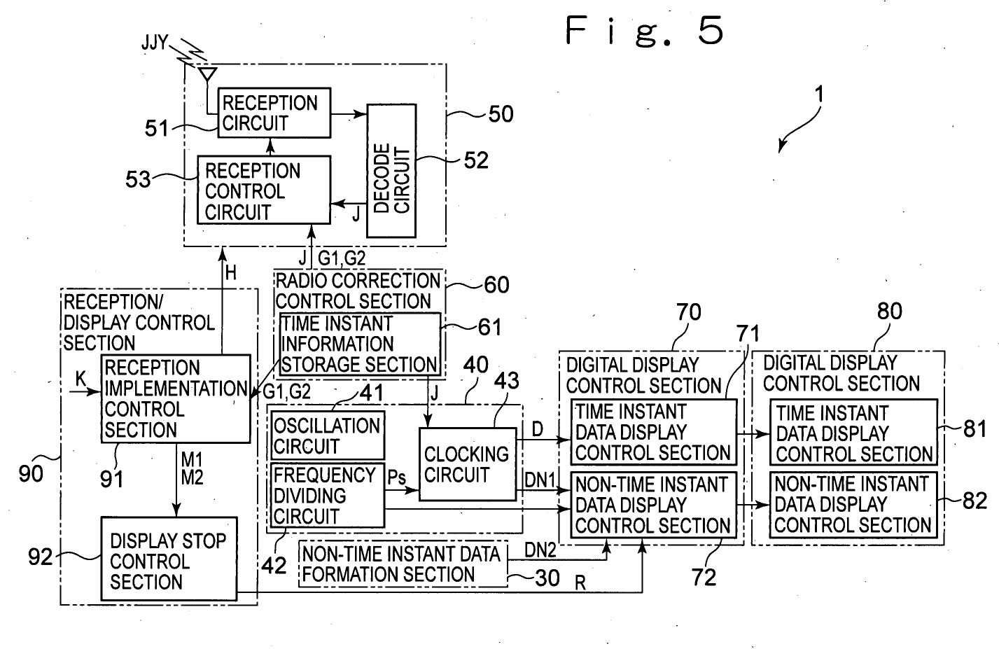

Next, there is explained about a function of the digital display type radio-corrected wristwatch 1 having a structure like the above on the basis of a functional relation block diagram shown in FIG. 5.

The digital display type radio-corrected wristwatch 1 has a reception/display control section 90 as a non-time instant data display control means, in addition to a timepiece circuit main body section 40, a radio correction mechanism main body section 50, a radio correction control section 60, a digital display control section 70 and a digital display section 80.

The timepiece circuit main body section 40 is a main body section of the normal timepiece circuit having a quartz oscillator, and includes an oscillation circuit 41 including the quartz oscillator, a frequency dividing circuit 42 which frequency-divides a clock pulse from the oscillation circuit 41 to thereby generate a frequency-divided pulse, and a clocking circuit 43 as a timepiece circuit, which counts a second pulse Ps in the form of the frequency-divided pulse and forms the hour/minute/second data Dt as the time instant data. Incidentally, the clocking circuit 43 functions also as a non-time instant data generation means, and forms the calendar data Dn1 corresponding to the non-time instant data Dn.

In this instance, the radio-corrected timepiece 1 additionally possesses a non-time instant data formation section 30 shown by an imaginary line in FIG. 5. In this instance, the non-time instant data formation section 30 monitors a used electric power quantity of the battery 5, and generates the battery residual quantity Dn2 as the non-time instant data Dn. Also this non-time instant data formation section 30 is included in the timepiece IC 21. Incidentally, in a case where the radio-corrected timepiece 1 has in combination a function completely different from the timepiece function like a pedometer, a step number data and the like are also included in the non-time instant data Dn2 of a 2nd kind. However, it follows that, of course, the non-time instant data Dn2 like the step number data is processed by an integrated circuit different from the timepiece IC 21. Further, in a case where the radio-corrected timepiece 1 functions also as a stopwatch capable of storing an intermediate split time, if the radio-corrected timepiece 1 is set to a stopwatch mode, a clocking data of the stopwatch is handled as the non-time instant data Dn2, and can be displayed in the non-time instant data display section 13a instead of the calendar data Dn1 for instance. The stopwatch data Dn2 in the form of this non-time instant data is stop-controlled in its display similarly to the calendar data Dn1 detailedly mentioned below. If desired, a stopwatch function can be incorporated to the timepiece IC 21.

Here, a portion other than the quartz oscillator 41 (omitted in FIG. 2) of the timepiece circuit main body section 40 and the digital display control section 70 are included in the timepiece IC 21. On'the other hand, a portion other than the reception antenna 7 of the radio correction mechanism main body section 50 and the radio correction control section 60 are included in the reception IC 22. The reception/display control section 90 may be included in the timepiece IC 21 or included in the reception IC 22, and it is included in the reception IC in a case where a general-purpose property of the timepiece IC 21 is emphasized and included in the timepiece IC in a case where the reception IC is simplified.

The radio correction mechanism main body section 50 has a reception circuit 51 receiving the standard wave signal JJY in cooperation with the reception antenna 7, and a decode circuit 52 taking out a time instant information J from the standard wave JJY received by the reception circuit 51, in addition to the reception antenna 7. The radio correction mechanism main body section 50 has additionally a reception control circuit 53 which gives a reception start signal F to the reception circuit 51 to thereby start a reception of the standard wave JJY by the reception circuit 51, and which judges whether or not the reception of the standard wave JJY by the reception circuit 51 and an extraction of the time instant information J by the decode circuit 52 have been normally performed. In a case where the reception/extraction of the time instant information J has been normally performed, the reception control circuit 53 generates a normal completion (reception success) signal G1 and the reception time instant information J and, in a case where it has failed in the reception/extraction of the time instant information J, generates a reception failure signal G2.

In a case where the radio correction control section 60 has received the normal completion (reception success) signal G1 and the reception time instant information J from the radio correction mechanism main body section 50, it stores the radio correction time instant information J to a time instant information storage section 61, sends the time instant information J to the clocking circuit 43 of the timepiece circuit main body section 40 to thereby correct a clocking value of the clocking circuit 43, and sends the normal completion (reception success) signal G1 to a later-mentioned reception implementation control section 91 of the reception/display control section 90. On the other hand, in a case where the radio correction control section 60 has received the reception failure signal G2, it sends the reception failure signal G2 to the reception implementation control section 91 of the reception/display control section 90.

The reception/display control section 90 as a non-time instant data display control means has the reception implementation control section 91 and a display stop control section 92 in order to control the reception of the standard wave JJY and a display stop of the non-time instant data Dn.

At a previously appointed or previously decided time instant (e.g., a specified time instant in a normal sleeping time zone, e.g., AM 2 o'clock) or every indicated time instant, the reception implementation control section 91 gives a reception implementation indication signal H to the reception control circuit 53 of the radio correction mechanism main body section 50 in order to start a radio correction operation, thereby causing the reception control circuit 53 to generate the reception start signal F. More detailedly, the reception implementation control section 91 previously holds in its inside an appointed or scheduled time instant information for instance and, if a time instant information receiving from the clocking circuit 43 coincides with the appointed or scheduled time instant information, it generates the reception implementation indication signal H. Incidentally, the appointed or scheduled time instant information may be held in the timepiece circuit main body part 50 side instead of being held in the reception implementation control section 91. Further, also in a case where the reception implementation control section 91 has received an indication K of a radio correction operation by a press of a push button switch or the like by a user, it generates the reception implementation indication signal H.

Incidentally, additionally, after the reception implementation control section 91 has generated the reception implementation indication signal H, every time it receives the reception failure signal G2, it generates another reception implementation indication signal H in a predetermined repeat timing, thereby repeating a radio correction indication. This repeat control may be adapted so as to be performed every hour on the hour, or performed just after the reception of the reception failure signal G2 while being limited to a predetermined plural times, or performed just after the reception of the reception failure signal G2 while being limited to the predetermined plural times only in a case where the indication K has been received.

Further, when the reception implementation control section 91 generates the reception implementation indication signal H, at the same time, it gives a non-time instant information display stop control start signal M1 to a display stop control section 92 to thereby cause the display stop control section 92 to output a non-time instant information display stop signal R, and additionally, every time the normal completion (reception success) signal G1 or the reception failure signal G2 is received, it gives a non-time instant information display stop control release signal M2 to the display stop control section 92 to thereby cause the display stop control section 92 to stop a transmission of the non-time instant information display stop signal R.

The digital display section 80 as the digital type display is constituted by the liquid crystal display part 10 or the liquid crystal panel 11. In this block diagram, the digital type display section like the liquid crystal display part 10 is denoted by the reference numeral 80. The digital display section 80 has a time instant data digital display section 81 and a non-time instant data digital display section 82, and the digital display control section 70 has a time instant data display control section 71 and a non-time instant data display control section 72.

The time instant data display control section 71 causes the time instant data (hour/minute/second data) Dt of the clocking circuit 43 of the timepiece circuit main body section 40 to display in the time instant data digital display section, 81 of the digital display section 80. In a case where the clocking circuit 43 of the timepiece circuit main body section 40 has received the radio correction time information J, this time instant data Dt becomes a time instant data having been corrected On the basis of the time instant information J.

The non-time instant data display control section 72 adopts two kinds of states of a display possible state Q1 (not shown in the drawing) and a display stop state Q2 (not shown in the drawing) and, in a case existing in the display possible state Q1 (not shown in the drawing), it causes the non-time instant data Dn like the calendar data (day/day of the week data) to display in the non-time instant data digital display section 82 of the digital display section 80.

The non-time instant data display control section 72 of the digital data display control section 70 adopts normally the display possible state Q1 (not shown in the drawing) and, while the non-time instant information display stop signal R from the display stop control section 92 of the reception/display control section 90 is being inputted, it is set to the display stop state Q2 (not shown in the drawing), and stops a display of the non-time instant data Dn.

That is, if the reception implementation control section 91 generates the non-time instant information display stop control start signal M1 at the same time as it generates the reception implementation indication signal H, since the display stop control section 92 sends the display stop signal R to the non-time instant data display control section 72, a display of the non-time instant data Dn (i.e., Dn1 and Dn2) is stopped. This display stop of the non-time instant data Dn is released by the fact that the reception implementation control section 91 receives the reception success signal G1 or the reception failure signal G2 and generates the non-time instant information display stop control release signal M2 and, under a control of the display stop control section 92, the non-time instant data display control section 72 returns to the display possible state Q1 (not shown in the drawing), so that the display of the non-time instant data Dn is restarted.

Accordingly, while the reception of the standard wave JJY is being performed by the radio correction mechanism main body section 50, since the signal does not flow through the non-time instant data displaying wiring or electrically conducting path Lnj, Bnj, Cnj, Anj, and there is stopped the display of the non-time instant data Dn by the non-time instant data digital display section 82 of the digital display section 80, there is no fear that the reception of the standard wave JJY in the reception antenna 7 is hindered by a noise that the reception of the standard wave JJY of the radio correction mechanism main body section 50 generates in a case where the signal passes through the non-time instant data displaying wiring Lnj, Bnj, Cnj, Anj. As a result, it becomes possible to dispose the reception antenna 7 while adjoining the connector 27 existing in the one side 11b of the liquid crystal panel 11, so that a miniaturization of the timepiece 1 can be intended.

Here, the digital display section 80 comprises the liquid crystal panel 11 of the liquid crystal display part 10, and the time instant data digital display section 81 and the non-time instant data digital display section 82 comprise respectively the display parts 12 and 13 of the liquid crystal panel 11.

In the above, a function block denoted as the “-- circuit” or “- section” may be, so long as it can achieve a function that the function block must achieve, an electric/electronic circuit (including a logic circuit) constituted so as to achieve the specified function, or may be a combination of a microprocessor and a program. Further, each of the signals may be an electric/electronic signal, or may be a data or an information, which is processed in an implementation process of the program.

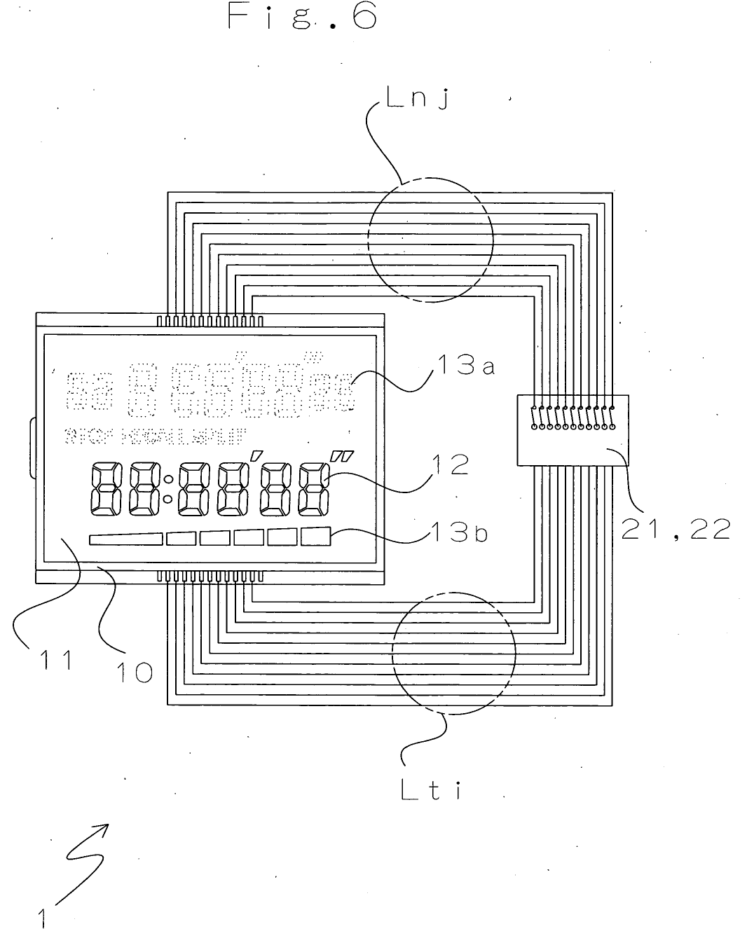

Next, about an operation of the digital display type radio-corrected timepiece constituted like the above, there is simply explained on the basis of FIG. 6, in which the operation of the timepiece 1 has been schematically shown, in addition to FIG. 1 to FIG. 5.

For example, if a user presses the push button switch or the like to thereby generates the radio correction indication signal K, the reception implementation control section 91 of the reception/display control section 90 gives the non-time instant information display stop start signal M1 to the display stop control section 92, and gives the reception implementation indication signal H to the reception control circuit 53 of the radio correction mechanism main body section 50. The display stop control section 92 gives, in compliance with the signal M1, the non-time instant information display stop signal R to the non-time instant data display control section 72, thereby stopping the display of the non-time instant information Dn. On the other hand, the reception control circuit 53 gives the reception start signal F to the reception circuit 51, thereby starting the reception.

Accordingly, while the integrated circuits 21, 22 including the reception IC 22 receive the reception start signal F and the reception of the standard wave JJY by the reception antenna 7, i.e., the reception of the time instant information J, is performed, the display through the non-time instant data display output line Lnj is made an OFF state, and a transmission/display of the non-time instant data Dn through the non-time instant data display output line Lnj is stopped. As a result, as understood from FIG. 6, there is vanished a display itself of the display part 13a of the calendar data Dn1 corresponding to the non-time instant data Dn. Under this state, since the calendar data Dn1 through the non-time instant data display output line Lnj and a transmission of its display control signal to the liquid crystal panel 11 are being stopped, there is no fact that a displaying electric signal flows to a vicinity of the upper edge part 11b of the liquid crystal panel 11, in which the reception antenna 7 has been disposed, so that, even if the reception antenna 7 is disposed while adjoining the upper edge part 11b of the liquid crystal panel 11, the reception of the standard wave JJY by the reception antenna 7 can be performed without undergoing the noise by the display signal. Accordingly, in the digital display type radio-corrected timepiece 1, a signal reception performance of the reception antenna can be maintained while avoiding the increase in the size.

If succeeded in an obtainment of the time instant information J by the reception of the standard wave JJY, the time instant data Dt of the clocking circuit 43 from the reception control circuit 53 through the radio correction control section 60 is corrected on the basis of the reception time instant information J, the reception/display control section 90 stops a sending of the non-time instant information display stop signal R in compliance with the reception of the reception success signal G1, the non-time instant data display control section 72 makes the display of the non-time instant data Dn possible, and the display of the non-time instant data Dn is restarted by the non-time instant data digital display section 82.

In the above, although there has been explained about the instance in which all of the non-time instant data Dn1, Dn2 are inputted to the liquid crystal panel 11 from the terminals 15, 25 located adjacent to the reception antenna 7 in the 12-hour side edge part 11b of the liquid crystal panel 11 and the connector 27, there may be adapted such that one part of the non-time instant data Dn, e.g., the battery residual quantity data D2, is inputted to the liquid crystal panel 11 by utilizing the terminals 14, 24 of the side edge part 11a and one part of the connector 26 instead of the side edge part 11b. In that case, the non-time instant data Dn inputted from the side edge part. 11a may be displayed without being stopped also during the reception/extraction of the time instant information J of the standard wave JJY. Accordingly, it follows that the display stop control section 92 and the non-time instant data display control section 72 control the stop of the display in compliance with the kinds Dn1, Dn2 of the non-time instant data Dn. However, if desired, the non-time instant data Dn2 may be display-stopped as well.

Additionally, e.g., in a case where the reception antenna 7 is disposed in a 12-hour side shown in FIG. 1 with respect to the liquid crystal panel 11, and in a case where the connector 27 of the terminals 15, 25 is disposed in a side edge part separated from the reception antenna 7 like in a 3 o'clock side (right side edge of the liquid crystal panel 11) or a 9 o'clock side (left side edge of the liquid crystal panel 11) not in a 12 o'clock side, the non-time instant data Dn may be displayed without being stopped also during the reception/extraction of the time instant information J of the standard wave JJY.

What is claimed is:

1. A digital display type radio-corrected timepiece having a display digital-displaying a time instant data including an hour/minute, having:
a reception antenna disposed near one side of the display and receiving a standard wave signal including a time instant information,
a timepiece circuit forming a time instant data corrected on the basis of the time instant information of the standard wave signal received by the antenna, and
a time instant data displaying output line comprising a wiring for sending a displaying output signal including the time instant data from the timepiece circuit to the display,
wherein the time instant data displaying output line is connected to the display in a place, within the display, different from the one side adjoining the reception antenna.

2. A digital display type radio-corrected timepiece according to claim 1, wherein the display is constituted so as to digital-display a non-time instant data other than the time instant data,
the radio corrected timepiece additionally has:
a non-time instant data generation means forming the non-time instant data,
a non-time instant data displaying output line comprising a wiring connecting the non-time instant data generation means and the one side of the display, and
a non-time instant data display control means controlling a transmission of the non-time instant data to the display through the non-time instant data displaying output line, and
the non-time instant data display control means is constituted so as to stop the transmission of the non-time instant data to the display during the reception antenna is receiving the standard wave signal in order that the timepiece circuit performs a time instant correction on the basis of the time instant information of the standard wave signal.

3. A digital display type radio-corrected timepiece according to claim 2, wherein the non-time instant data is a calendar data denoting a day or a term longer than the day, or a data not depending on the time instant.

4. A digital display type radio-corrected timepiece according to claim 2, wherein the timepiece circuit and the non-time instant data display control means are mounted to a circuit substrate, and the circuit substrate possesses a wiring pattern constituting the time instant data displaying output line and the non-time instant data displaying output line.

5. A digital display type radio-corrected timepiece according to claim 4, wherein the display possesses in the one side thereof a non-time instant data displaying input terminal including many display signal inputting contact portions, the non-time instant data displaying output line possesses in an end part of the display side a non-time instant data displaying output terminal including many display signal outputting contact portions, and the non-time instant data displaying output terminal of the non-time instant data displaying output line is connected through a connector to the non-time instant data displaying input terminal of the display between the display and the reception antenna.

6. A digital display type radio-corrected timepiece according to claim 1, wherein the display is a liquid crystal display type, a light emitting diode type, an organic EL display type, or an electronic paper type.

7. A digital display type radio-corrected timepiece according to claim 1, wherein the display possesses an elongated plane shape, and the reception antenna is disposed along a long side forming the one side of the display.

8. A digital display type radio-corrected timepiece according to claim 1, wherein the reception antenna is disposed in a 12 o'clock side or a 6 o'clock side in a case of an analog type display.

9. A digital display type radio-corrected timepiece according to claim 1, wherein it is in the form of a wristwatch.

10. A standard wave receiving method of a digital display type radio-corrected timepiece, wherein there has been adapted such that when correcting a display time instant of a display, which performs a digital display, on the basis of a time instant information included in a standard wave signal received by a reception antenna which is disposed in one side of the display, an input of a display signal from the one side of the display to the display is stopped while the time instant information is being received.
